(19) United States
(12) Patent Application Publication
(10) Pub. No.: US 2023/0391634 A1
(43) Pub. Date: Dec. 7, 2023

(54) METHOD FOR ISOLATING AN AQUEOUS HYDROCHLORIC ACID SOLUTION OF FECL3 FROM AN AQUEOUS MULTI-COMPONENT SYSTEM

(71) Applicant: Bayer Aktiengesellschaft, Leverkusen (DE)

(72) Inventors: Michael ESSER, Leverkusen (DE); Stephanie PEPER, Leverkusen (DE); Karsten BECKER, Leverkusen (DE); Werner BÄCKER, Leverkusen (DE)

(21) Appl. No.: 18/278,724

(22) PCT Filed: Feb. 21, 2022
(86) PCT No.: PCT/EP2022/054206

§ 371 Date: Aug. 24, 2023

(30) Foreign Application Priority Data
Feb. 24, 2021 (EP) 21158868.6

(51) Int. Cl. C01G 49/00; C01G 49/10

(52) U.S. Cl. CPC C01G 49/0009; C01G 49/10

(57) ABSTRACT

The invention relates to a method for isolating an aqueous hydrochloric acid solution of FeCl₃ from an aqueous multi-component system.

The invention relates to a method for isolating an aqueous hydrochloric acid solution of FeCl₃ from an aqueous multi-component system, comprising the following steps:
a) an aqueous hydrochloric acid multi-component system comprising Fe³⁺ ions is provided,
b) the multi-component system from step a) is extracted with an organic solvent,
c) the organic solvent from step b) is extracted with water, wherein the aqueous hydrochloric acid solution of FeCl₃ is obtained.

In many syntheses carried out on an industrial scale, FeCl₃ is an important material of value which may be used as an oxidizing agent for example. After use as an oxidizing agent, it is often present in the form of FeCl₂ together with other components in a multi-component system. By adding oxidizing agents such as Cl₂ for example to the multi-component system, the FeCl₂ may be oxidized again to FeCl₃. In order for it to be possible to reuse this, it is necessary to isolate the aqueous hydrochloric acid solution of FeCl₃ from the multi-component system.

In the prior art, isolation methods are described in which, in a first step, an aqueous hydrochloric acid multi-component system comprising Fe³⁺ ions is provided. In a second step, this multi-component system is then extracted with an organic solvent in order to transfer the largest possible proportion of the dissolved FeCl₃ into the organic phase. In a third step, the organic solvent is extracted with water, wherein the aqueous hydrochloric acid solution of FeCl₃ is obtained.

A method of the type mentioned above is described, for example, in EP 0 675 077.

However, a disadvantage of the known method is that the yield of aqueous hydrochloric acid solution of FeCl₃ on isolation from the multi-component system is insufficient, i.e. a significant proportion of the FeCl₃ remains in the multi-component system and thus cannot be reused.

The object of the present invention, therefore, was to provide a method for isolating an aqueous hydrochloric acid solution of FeCl₃ from an aqueous multi-component system, in which a particularly high yield of aqueous hydrochloric acid solution of FeCl₃ is obtained.

The object is achieved by a method for isolating an aqueous hydrochloric acid solution of FeCl₃ from an aqueous multi-component system, comprising the following steps:
a) an aqueous hydrochloric acid multi-component system comprising Fe³⁺ ions is provided,
b) the multi-component system from step a) is extracted with an organic solvent,
c) the organic solvent from step b) is extracted with water, wherein the aqueous hydrochloric acid solution of FeCl₃ is obtained,
characterized in that, in the multi-component system of step a), the molar ratio of aqueous HCl to Fe³⁺ ions is ≥1.3:1.

Using the method according to the invention, it has been shown, surprisingly, that a particularly high proportion of the FeCl₃ originally present in the multi-component system can be isolated in the form of the aqueous hydrochloric acid solution of FeCl₃.

It is provided in accordance with a preferred embodiment that the molar ratio of aqueous HCl to Fe³⁺ ions is in the range from 1.5:1 to 2.5:1 and is particularly preferably in the range from 1.8:1 to 2.3:1.

It is also further preferred when the molar ratio of aqueous HCl to Fe³+ ions is in the range from 1.3:1 to 1.8:1, particularly preferably in the range from 1.3:1 to 1.7:1 and especially preferably in the range from 1.3:1 to 1.5:1.

It is also preferred when the organic solvent comprises or consists of molecules comprising heteroatoms, preferably oxygen, sulfur or nitrogen atoms and particularly preferably oxygen atoms.

It is further preferred when the organic solvent comprises or consists of one or more of the following organic solvents: ethers, alcohols, ketones, and particularly preferably comprises or consists of one or more of the following organic solvents: 2-methoxy-2-methylpropane, diisopropyl ether, butanol, 2-methyl-1-propanol, 2-ethylhexan-1-ol, 4-methylpentan-2-one, 1-chloro-4-methylpentan-2-one, 3-chloro-4-methylpentan-2-one.

It is especially preferred if the organic solvent comprises or consists of 4-methylpentan-2-one.

It is provided in accordance with a further preferred embodiment that the extraction in step b) is carried out with the organic solvent in countercurrent.

It is also preferred if the extraction in step b) is a multi-stage extraction, preferably in 3 to 7 stages.

It is also preferred when the extraction in step c) is carried out with water in countercurrent.

It is also preferred if the extraction in step c) is a multi-stage extraction, preferably in 2 to 7 stages.

It is also particularly preferred when the organic solvent comprises or consists of 4-methylpentan-2-one, the extraction in step b) is carried out with the organic solvent in countercurrent in 3 to 7 stages and the extraction in step c) is a multi-stage extraction in countercurrent in 2 to 6 stages.

The method may preferably be carried out at a temperature in the range of 0 to 80° C., particularly preferably in the range of 10 to 50° C., and especially preferably in the range of 20 to 40° C.

It is also especially preferred when the organic solvent comprises or consists of 4-methylpentan-2-one, the extraction in step b) is carried out with the organic solvent in countercurrent in 3 to 7 stages, the extraction in step c) is a multi-stage extraction in countercurrent in 2 to 6 stages and the method is carried out at a temperature in the range of 20 to 40° C.

It is also preferable when the method is carried out continuously. It is particularly preferred when the organic solvent after the extraction with water in step c) is reused in step b).

Also preferred is a method in which the concentration of Fe³⁺ ions in the aqueous multi-component system of step a) is in the range of 0.01 to 2.3 mol/kg, particularly preferably in the range of 0.1 to 2 mol/kg and especially preferably in the range of 1.1 to 1.7 mol/kg.

It is also especially preferred when the organic solvent comprises or consists of 4-methylpentan-2-one, the extraction in step b) is carried out with the organic solvent in countercurrent in 3 to 7 stages, the extraction in step c) is a multi-stage extraction in countercurrent in 2 to 6 stages, the method is carried out at a temperature in the range of 20 bis 40° C. and the concentration of Fe³⁺ ions in the aqueous multi-component system of step a) is in the range of 1.1 to 1.7 mol/kg.

Also advantageous is a method in which the aqueous multi-component system of step a) comprises dissolved alkali metal salts and/or alkaline earth metal salts and preferably NaCl and/or NaSCN. It is particularly advantageous when the aqueous multi-component system of step a) comprises dissolved NaCl in the range of 0.01 to 3.5 mol/kg, preferably in the range of 0.1 to 1.5 mol/kg and particularly preferably in the range of 0.3 to 1 mol/kg. The method is also particularly suitable for separating Fe²⁺ ions, which have not been oxidized to Fe³⁺ ions, from FeCl₃.

The examples which follow elucidate the invention more particularly.

The experiments for the extraction of FeCl₃ into the organic phase were carried out in a 7-stage mixer-settler plant in countercurrent (in some experiments no further changes occurred in the latter extraction stages). Aqueous multi-component systems which each contained 21% by weight FeCl₃, 1% by weight FeCl₂, 3% by weight NaCl and varying amounts of HCl were extracted with various solvents in countercurrent. In all experiments, NaCl and FeCl₂ remained in the water phase. In each case, ca. one equivalent of HCl passed into the organic phase with the FeCl₃.

The experiments for the back extraction of the organic solvent from step b) with water were carried out in a 7-stage mixer-settler plant in countercurrent (in all experiments no further changes occurred in the latter extraction stages).

### EXAMPLE 1

An aqueous multi-component system was extracted at 30° C. with 0.99 kg/kg of 4-methylpentan-2-one. The initial ratio of aqueous HCl to Fe³⁺ ions in the aqueous multi-component system was 2.6 mol/mol.

The yield of FeCl₃ in the organic phase after extraction was 100%.

### EXAMPLE 2

An aqueous multi-component system was extracted at 30° C. with 0.85 kg/kg of 4-methylpentan-2-one. The initial ratio of aqueous HCl to Fe³⁺ ions in the aqueous multi-component system was 1.3 mol/mol.

The yield of FeCl₃ in the organic phase after extraction was 96.3%.

### EXAMPLE 3

An aqueous multi-component system was extracted at 40° C. with 0.99 kg/kg of n-butanol. The initial ratio of aqueous HCl to Fe³⁺ ions in the aqueous multi-component system was 1.8 mol/mol. The yield of FeCl₃ in the organic phase after extraction was 78.8% by weight.

### EXAMPLE 4

An aqueous multi-component system was extracted at 30° C. with 0.60 kg/kg of 2-methoxy-2-methylpropane. The initial ratio of aqueous HCl to Fe³⁺ ions in the aqueous multi-component system was 2.1 mol/mol, and 22% by weight FeCl₃ was present in the system. The yield of FeCl₃ in the organic phase after extraction was 99.2% by weight.

### EXAMPLE 5

An aqueous multi-component system was extracted at 10° C. with 0.61 kg/kg of 2-methoxy-2-methylpropane. The initial ratio of aqueous HCl to Fe³⁺ ions in the aqueous multi-component system was 1.5 mol/mol, and 24% by weight FeCl₃ was present in the system. The yield of FeCl₃ in the organic phase after extraction was 92.9% by weight.

### EXAMPLE 6

An aqueous multi-component system was extracted at 30° C. with 0.57 kg/kg of diisopropyl ether. The initial ratio of aqueous HCl to Fe³⁺ ions in the aqueous multi-component system was 1.5 mol/mol, and 24% by weight FeCl₃ was present in the system. The yield of FeCl₃ in the organic phase after extraction was 79.9% by weight.

### EXAMPLE 7

The organic solvent of step b) from Example 2, which was charged with FeCl₃ and HCl, was extracted with 0.54 kg/kg of water. FeCl₃ and HCl were entirely extracted into water. The organic solvent 4-methylpentan-2-one discharged contained no iron and only traces of HCl.

### EXAMPLE 8

The organic solvent of step b) from Example 4, which was charged with FeCl3 and HCl, was extracted with 0.6 kg/kg of water. FeCl₃ and HCl were entirely extracted into water. The 2-methoxy-2-methylpropane discharged contained no iron and only traces of HCl.

### COMPARATIVE EXAMPLE

An aqueous multi-component system was extracted at 40° C. with 0.99 kg/kg of 4-methylpentan-2-one. The initial ratio of aqueous HCl to Fe³⁺ ions in the aqueous multi-component system was 1.2 mol/mol, and 22% by weight FeCl₃ was present in the system. The yield of FeCl₃ in the organic phase after extraction was 62.9% by weight.

1. Method for isolating an aqueous hydrochloric acid solution of FeCl₃ from an aqueous multi-component system, comprising the following steps:
a) an aqueous hydrochloric acid multi-component system comprising Fe³⁺ ions is provided,
b) the multi-component system from step a) is extracted with an organic solvent,
c) the organic solvent from step b) is extracted with water, wherein the aqueous hydrochloric acid solution of FeCl₃ is obtained,
characterized in that
in the multi-component system of step a), the molar ratio of aqueous HCl to Fe³⁺ ions is ≥1.3:1.

2. Method according to claim 1, characterized in that the molar ratio of aqueous HCl to Fe³⁺ ions is in the range from 1.5:1 to 2.5:1 and preferably in the range from 1.8:1 to 2.3:1.

3. Method according to either of claim 1 or 2, characterized in that the organic solvent comprises or consists of molecules comprising heteroatoms, preferably oxygen, sulfur or nitrogen atoms and particularly preferably oxygen atoms.

4. Method according to either of claim 1 or 2, characterized in that the organic solvent comprises or consists of one or more of the following organic solvents: ethers, alcohols, ketones, and preferably comprises or consists of one or more of the following organic solvents: 2-methoxy-2-methylpropane, diisopropyl ether, butanol, 2-methyl-1-propanol, 2-ethylhexan-1-ol, 4-methylpentan-2-one, 1-chloro-4-methylpentan-2-one, 3-chloro-4-methylpentan-2-one.

5. Method according to either of claim 1 or 2, characterized in that the organic solvent comprises or consists of 4-methylpentan-2-one.

6. Method according to any of claims 1 to 5, characterized in that the extraction in step b) is carried out with the organic solvent in countercurrent.

7. Method according to any of claims 1 to 6, characterized in that the extraction in step b) is a multi-stage extraction, preferably in 3 to 7 stages.

8. Method according to any of claims 1 to 7, characterized in that the extraction in step c) is carried out with water in countercurrent.

9. Method according to any of claims 1 to 8, characterized in that the extraction in step c) is a multi-stage extraction, preferably in 2 to 7 stages.

10. Method according to any of claims 1 to 9, characterized in that the method is carried out at a temperature in the range of 0 to 80° C., preferably in the range of 10 to 50° C. and particularly preferably in the range of 20 to 40° C.

11. Method according to any of claims 1 to 10, characterized in that said method is carried out continuously.

12. Method according to claim 11, characterized in that the organic solvent after the extraction with water in step c) is reused in step b).

13. Method according to any of claims 1 to 12, characterized in that the concentration of Fe³⁺ ions in the aqueous multi-component system of step a) is in the range of 0.01 to 2.3 mol/kg, preferably in the range of 0.1 to 2 mol/kg and particularly preferably in the range of 1.1 to 1.7 mol/kg.

14. Method according to any of claims 1 to 13, characterized in that the aqueous multi-component system of step a) comprises dissolved alkali metal salts and/or alkaline earth metal salts and preferably NaCl and/or NaSCN.

15. Method according to claim 14, characterized in that the aqueous multi-component system of step a) comprises dissolved NaCl in the range of 0.01 to 3.5 mol/kg, preferably in the range of 0.1 to 1.5 mol/kg and particularly preferably in the range of 0.3 to 1 mol/kg.
